(19) United States
(12) Patent Application Publication
(10) Pub. No.: US 2012/0198496 A1
(43) Pub. Date: Aug. 2, 2012

(54) Video Related Tag Generating Apparatus, Video Related Tag Generating Method, Video Interacting Method, Video Interacting System and Video Interacting Apparatus

(75) Inventor: Chin-Shan Yuan, Taipei (TW)

(73) Assignee: MODIOTEK CO., LTD., Hsinchu (TW)

(21) Appl. No.: 13/017,408

(22) Filed: Jan. 31, 2011

(51) Int. Cl. H04N 5/445

(52) U.S. Cl. 725/40

(57) ABSTRACT

A video related tag generating apparatus, a video related tag generating method, a video interacting method, a video interacting system and a video interacting apparatus are provided. The video interacting method includes the following steps. A video broadcast program is received via a video signal receiver, and a video related tag is received via a network interface. The video related tag relates to a target object, and the video broadcast program includes a video frame having the target object. A synchronous information, an object position and object information are generated according to the video related tag. A triggering region is generated according to the object position. The triggering region is synchronously overlapped on the video frame according to the synchronous information. A key-press signal is received to select the triggering region, such that the object information is overlapped on the video frame.

### BACKGROUND OF THE INVENTION

1. Field of the Invention

The invention relates in general to a video apparatus, and more particularly to a video related tag generating apparatus, a video related tag generating method, a video interacting method, a video interacting system and a video interacting apparatus.

2. Description of the Related Art

Watching the television is one of the most important entertainment activities, and the television signals may be classified into an analog television signal and a digital television signal. The analog television signal has been developed for a long time and widely used. An antenna is directly coupled to the television in the house to receive the analog television signal, or a cable supplied by the cable television provider is coupled to the television to receive the analog television signal.

In the existing art, however, the user only can passively and purely receive the video broadcast program on the television. When the video frame on the television displays the object interested by the user, the user cannot obtain the information associated with the object immediately and cannot interact with the video broadcast program.

### SUMMARY OF THE INVENTION

The invention is directed to a video related tag generating apparatus, a video related tag generating method, a video interacting method, a video interacting system and a video interacting apparatus. The video related tag of the video related tag generating apparatus, the video related tag generating method, the video interacting method, the video interacting system and the video interacting apparatus highly correlates with a content of a target object in the video broadcast program so as to enable the user to watch the video broadcast program in a non-monotonic manner and to interact with the contents of the video broadcast program via the video related tag.

According to a first aspect of the present invention, a video interacting method is provided. The method includes the following steps. A video broadcast program is received via a video signal receiver and a video related tag is received via a network interface. The video related tag relates to a target object, and the video broadcast program comprises a video frame having the target object. A synchronous information, an object position and object information are generated according to the video related tag. A triggering region is generated according to the object position. The triggering region is synchronously overlapped on the video frame according to the synchronous information. A key-press signal is received to select the triggering region, such that the object information is overlapped on the video frame.

According to a second aspect of the present invention, a method for generating a video related tag, which relates to a target object, is provided. The method id used for generating the video related tag according to a video broadcast program, the video broadcast program includes a video frame having the target object. The method includes the following steps. Synchronous information is generated according to the target object. An object position is generated according to the target object. Object information is generated according to the target object. The video related tag is generated according to the synchronous information, the object position and the object information.

According to a third aspect of the present invention, a video interacting apparatus is provided. The video interacting apparatus includes a video signal receiver, a network interface, a video related tag processing unit, a triggering region generating unit, and an image synchronizing unit. The video signal receiver receives a video broadcast program. The network interface receives a video related tag, which relates to a target object. The video broadcast program includes a video frame having the target object. The video related tag processing unit generates a synchronous information, an object position and object information according to the video related tag. The triggering region generating unit generates a triggering region according to the object position. The image synchronizing unit synchronously overlaps the triggering region on the video frame according to the synchronous information when the video frame is displayed. The video related tag processing unit receives a key-press signal to select the triggering region, such that the image synchronizing unit overlaps the object information on the video frame.

According to a fourth aspect of the present invention, a video interacting system including a video interacting apparatus and a triggering apparatus is provided. The video interacting apparatus includes a video signal receiver, a network interface, a video related tag processing unit, a triggering region generating unit and an image synchronizing unit. The video signal receiver receives a video broadcast program. The network interface receives a video related tag, which relates to a target object. The video broadcast program includes a video frame having the target object. The video related tag processing unit generates a synchronous information, an object position and object information according to the video related tag. The triggering region generating unit generates a triggering region according to the object position. The image synchronizing unit synchronously overlaps the triggering region on the video frame according to the synchronous information when the video frame is displayed. The triggering apparatus generates a key-press signal. The video related tag processing unit receives the key-press signal to select the triggering region, such that the image synchronizing unit overlaps the object information on the video frame.

According to a fifth aspect of the present invention, an apparatus for generating a video related tag is provided. The video related tag relates to a target object. The apparatus is used for generating the video related tag according to a video broadcast program. The video broadcast program includes a video frame having the target object. The apparatus includes a synchronous information generator, an object position generator, an object information generator and a video related tag generator. The synchronous information generator generates synchronous information according to the target object. The object position generator generates an object position according to the target object. The object information generator generates object information according to the target object. The video related tag generator generates the video related tag according to the synchronous information, the object position and the object information.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a flow chart showing a first video related tag generating method.

FIG. 2 is a block diagram showing a first video related tag generating apparatus.

FIG. 3 is a schematic illustration showing a video frame.

FIG. 4 is a flow chart showing a video interacting method.

FIG. 5 is a block diagram showing a video interacting apparatus.

FIG. 6 is a schematic illustration showing a first triggering region overlapped on the video frame.

FIG. 7 is a flow chart showing a second video related tag generating method.

FIG. 8 is a block diagram showing a second video related tag generating apparatus.

FIG. 9 is a schematic illustration showing a second triggering region overlapped on the video frame.

### DETAILED DESCRIPTION OF THE INVENTION

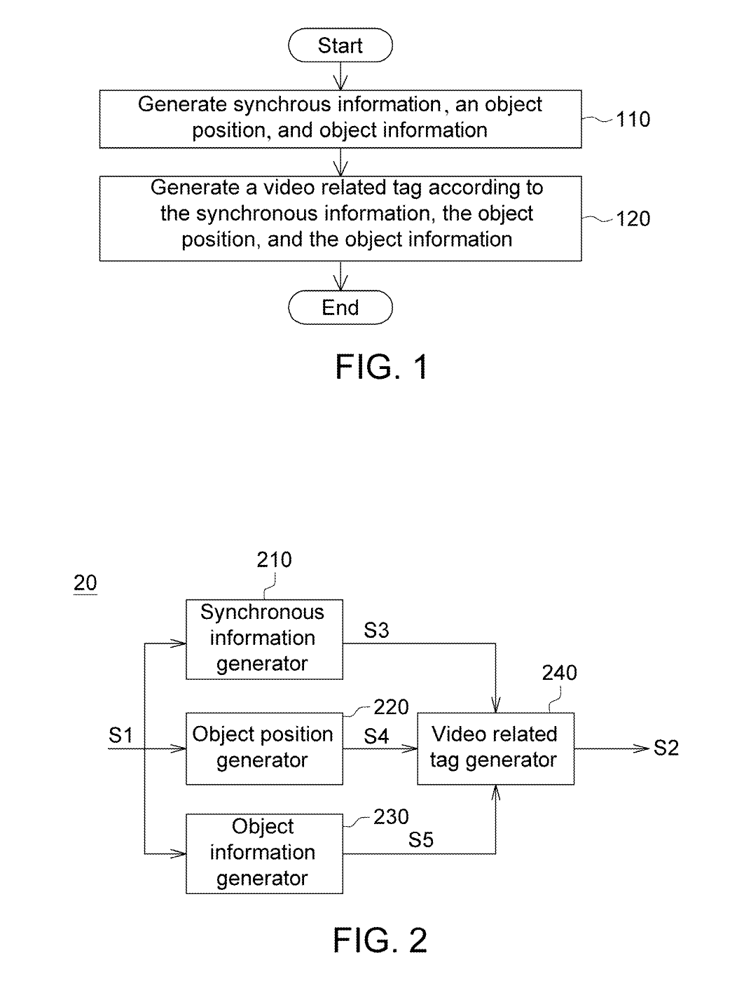

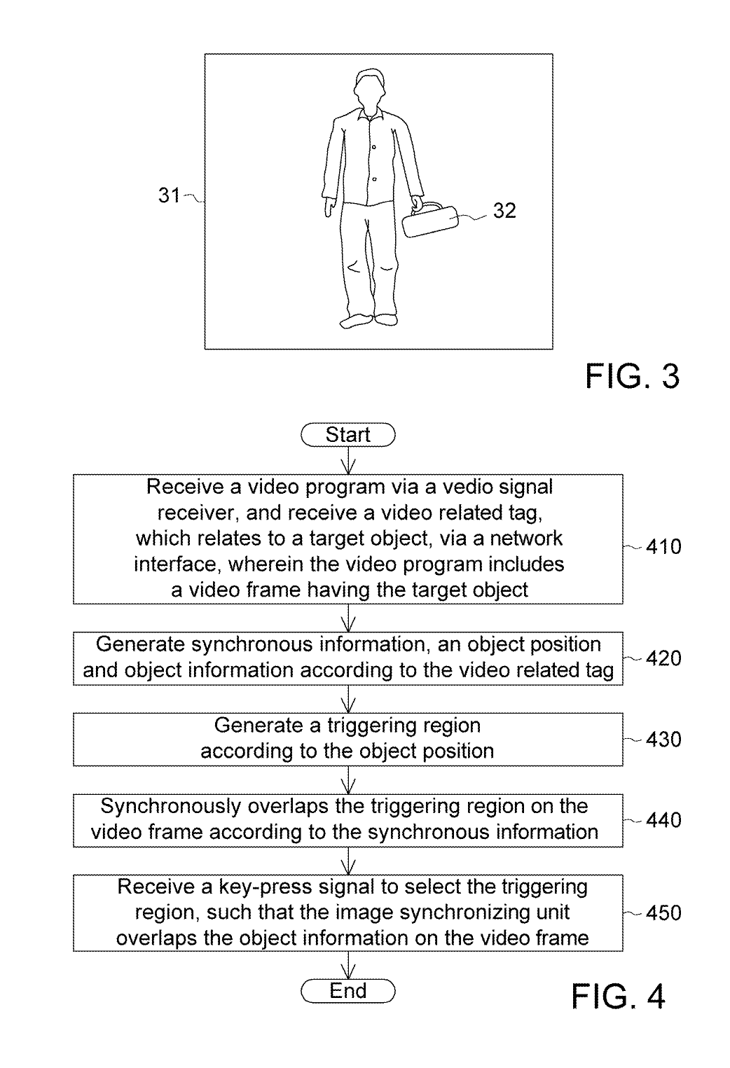

FIG. 1 is a flow chart showing a first video related tag generating method. FIG. 2 is a block diagram showing a first video related tag generating apparatus 20. FIG. 3 is a schematic illustration showing a video frame. Referring to FIGS. 1 to 3, the video related tag generating apparatus 20 and the video related tag generating method generate a video related tag S2 according to a video broadcast program S1, which includes a video frame 31 having a target object 32. The target object 32 may be any object, such as a person, goods, or a location or the like, interested by the audience. For the sake of illustration, the target object 32 illustrated in FIG. 3 is the purse.

The video related tag generating apparatus 20 includes a synchronous information generator 210, an object position generator 220, an object information generator 230 and a video related tag generator 240. The video related tag generating method may be applied to the generating apparatus 20 and includes the following steps. First, as shown in step 110, the synchronous information generator 210 generates synchronous information S3 according to the target object 32. The synchronous information S3 is, for example, a time stamp or a frame number. The object position generator 220 generates an object position S4 according to the target object 32. The object position S4 indicates the position where the target object 32 is located in the video frame 31. The object information generator 230 generates object information S5 according to the target object 32. The object information S5 includes, for example, the description associated with the target object 32, or is used for linking to at least one of an electronic commerce portal website, a website associated with the target object 32, information associated with the target object 32 and an advertisement. The description associated with the target object 32 may relate to, for example, the brand, price or location of sale of the target object. After the information link associated with the target object 32 is clicked and selected, the user can further watch the highlights or background stories of the video broadcast program S1 via a network interface 512.

Next, as shown in step 120, the video related tag generator 240 generates the video related tag S2 according to the synchronous information S3, the object position S4 and the object information S5. The generating apparatus 20 is disposed in, for example, a remote server, and the video related tag S2 is packaged into network packets, for example. The generating apparatus 20 can transfer the video related tag S2 to a client or clients via the network.

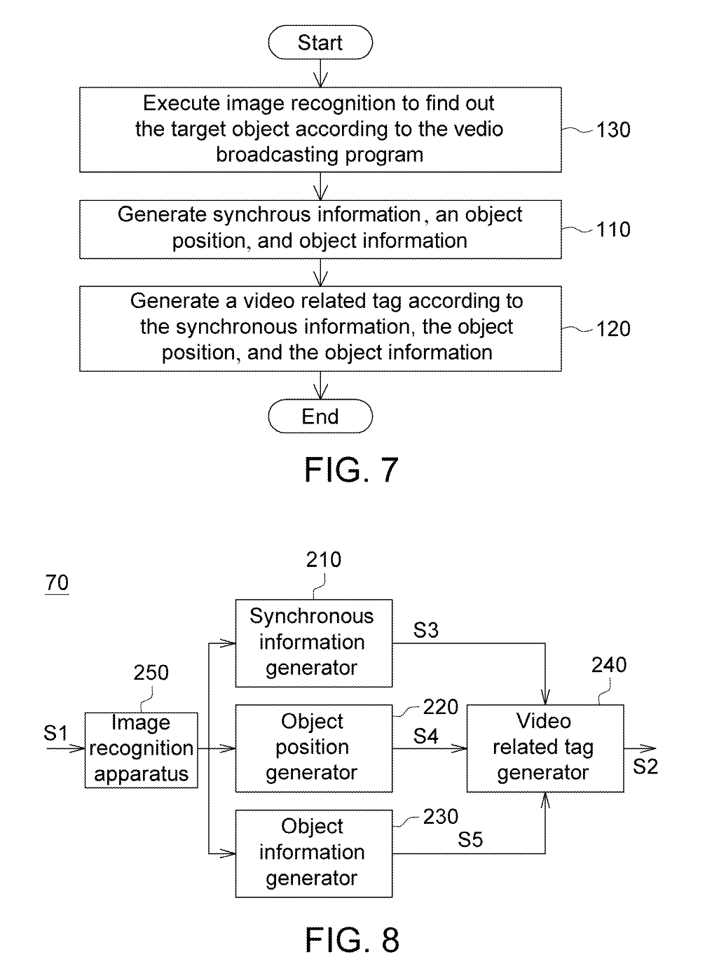

FIG. 7 is a flow chart showing a second video related tag generating method. FIG. 8 is a block diagram showing a second video related tag generating apparatus. Referring to FIGS. 7 to 8, there is a difference between the first video related tag generating method the second video related tag generating method, which is the second video related tag generating method further comprising step 130. There is a difference between the first video related tag generating apparatus the second video related tag generating apparatus, which is the second video related tag generating apparatus further comprising an image recognition apparatus 250. As shown in step 130, the image recognition apparatus 250 executes image recognition to find out the target object according to the video broadcast program.

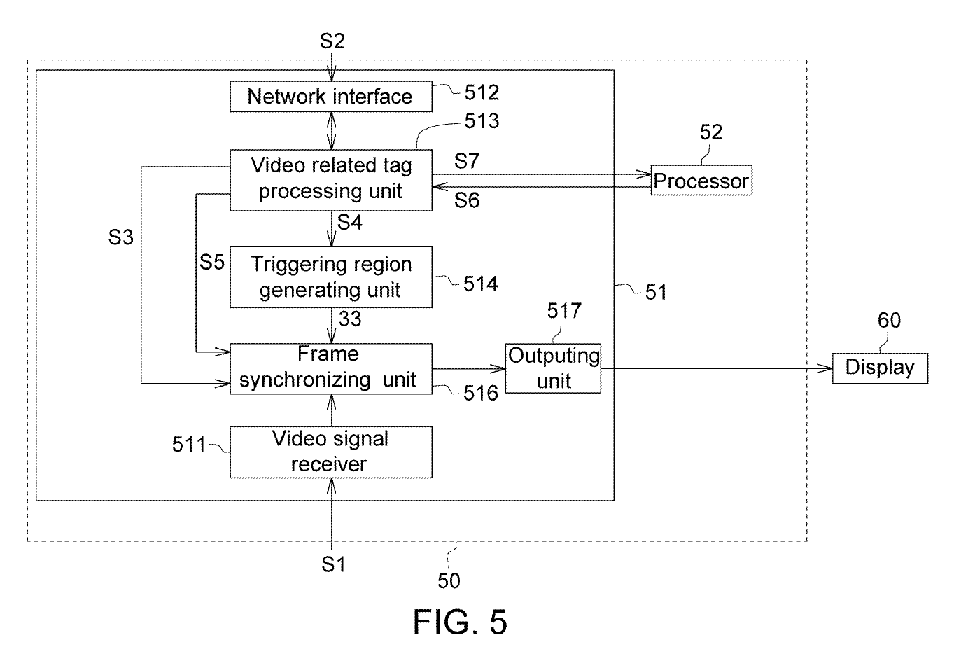

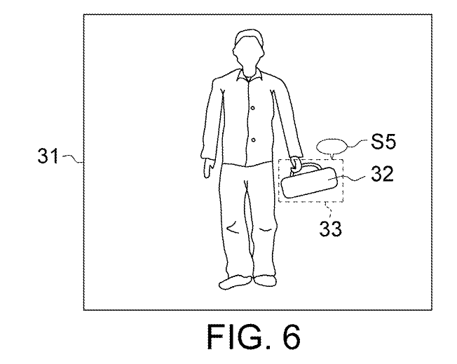

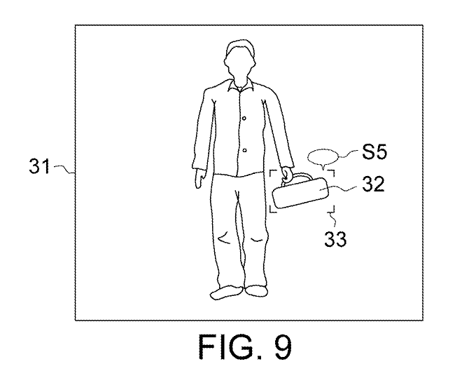

FIG. 4 is a flow chart showing a video interacting method. FIG. 5 is a block diagram showing a video interacting apparatus. FIG. 6 is a schematic illustration showing a first triggering region overlapped on the video frame. FIG. 9 is a schematic illustration showing a second triggering region overlapped on the video frame. Referring to FIGS. 4 to 6 and 9, a video interacting system 50 includes a video interacting apparatus 51 and a triggering apparatus 52. The video interacting apparatus 51 includes a video signal receiver 511, a network interface 512, a video related tag processing unit 513, a triggering region generating unit 514, an image synchronizing unit 516, and an outputting unit 517. The video interacting apparatus 51 is, for example, a set top box or may further be integrated with a display 60 to become a television. The triggering apparatus 52 could be any one user inputting interface, for example, a remote controller, a touch panel or input apparatus on the television. The outputting unit 517 is, for example, a graphical outputting interface.

The video interacting apparatus can be applied to the video interacting system 50 and includes the following steps. First, as shown in step 410, the video interacting apparatus 51 receives the video broadcast program S1 via the video signal receiver 511, and receives the video related tag S2 via the network interface 512. The video related tag S2 is generated by the generating apparatus 20, for example, and transferred to the network interface 512 via the network. The video broadcast program S1 received by the video signal receiver 511 includes the video frame 31 having the target object 32, and the video related tag S2 received by the network interface 512 relates to the target object 32.

Next, as shown in step 420, the video related tag processing unit 513 generates the synchronous information S3, the object position S4 and the object information S5 according to the video related tag S2. Then, as shown in step 430, the triggering region generating unit 514 generates a triggering region 33 according to an object position S5. The triggering region 33 may be displayed or hidden. The triggering region 33 could be displayed in different way. The triggering region 33 could be displayed a dashed frame such as FIG. 6, or upper quote and lower quote such as FIG. 9.

Next, as shown in step 440, the image synchronizing unit 516 synchronously overlaps the triggering region 33 on the video frame 31 according to the synchronous information S3 when the video frame 31 is displayed by the display 60. Finally, as shown in step 450, the user uses the triggering apparatus 52 to generate a key-press signal S6, and the video related tag processing unit 513 receives the key-press signal S6 to select the triggering region 33, such that the image synchronizing unit 516 overlaps the object information S5 on the video frame 31, and outputs to display 60 via the outputting unit 517.

The triggering region 33 and the object information S5 could be flexibly adjusted according to a resolution of the display 60. For example, the original resolution of the video related tag S2 is set to 320×240, but the resolution of the display 60 is 640×480. The triggering region 33 and the object information S5 could be flexibly adjusted 640×480 to match the resolution of the display 60.

In addition, in order to remind the user that the object information S5 is hidden in the video frame 31, the video related tag processing unit 513 can further output a notification signal S7 to the processor 522 of the triggering apparatus 52 according to the video related tag S2. The triggering apparatus 52 generates an indication signal, which indicates that the triggering region 33 is located on the video frame 31, according to the notification signal. The indication signal is, for example, an audible signal, a vibration signal or a lighting signal.

With the video related tag generating apparatus, the video related tag generating method, the video interacting method, the video interacting system and the video interacting apparatus, the user can not only watch the video broadcast program in a non-monotonic manner but also interact with the contents of the video broadcast program.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video interacting method, comprising:
receiving a video broadcast program via a video signal receiver and receiving a video related tag via a network interface, wherein the video related tag relates to a target object, and the video broadcast program comprises a video frame having the target object;
generating synchronous information, an object position and object information according to the video related tag;
generating a triggering region according to the object position;
synchronously overlapping the triggering region on the video frame according to the synchronous information;
receiving a key-press signal to select the triggering region, such that the object information overlapped on the video frame.

2. The method according to claim 1, further comprising:
outputting a notification signal to a triggering apparatus according to the video related tag, wherein
the triggering apparatus generates an indication signal, which indicates that the triggering region is located on the video frame, according to the notification signal.

3. The method according to claim 2, wherein the indication signal is an audible signal, a vibration signal or a lighting signal.

4. The method according to claim 1, wherein the triggering region is displayed.

5. The method according to claim 1, wherein the triggering region is hidden.

6. The method according to claim 1, wherein the object information used for linking to at least one of an electronic commerce portal website, a website associated with the target object, an information associated with the target object, and an advertisement.

7. A method for generating a video related tag, which relates to a target object, the method used for generating the video related tag according to a video broadcast program, the video broadcast program comprising a video frame having the target object, the method comprising:
generating a synchronous information, an object position, and a object information according to the target object; and
generating the video related tag according to the synchronous information, the object position and the object information.

8. The method according to claim 7, wherein the object information used for linking to at least one of an electronic commerce portal website, a website associated with the target object, an information associated with the target object, and an advertisement.

9. The method according to claim 7, further comprising:
executing image recognition to find out the target object according to the video broadcast program.

10. A video interacting apparatus, comprising:
a video signal receiver for receiving a video broadcast program;
a network interface for receiving a video related tag, which relates to a target object, wherein the video broadcast program comprises a video frame having the target object;
a video related tag processing unit for generating synchronous information, an object position and object information according to the video related tag;
a triggering region generating unit for generating a triggering region according to the object position;
an image synchronizing unit for synchronously overlapping the triggering region on the video frame according to the synchronous information when the video frame is displayed;
wherein the video related tag processing unit receives a key-press signal to select the triggering region, such that the image synchronizing unit overlaps the object information on the video frame.

11. The apparatus according to claim 10, wherein the triggering region is displayed.

12. The apparatus according to claim 10, wherein the triggering region is hidden.

13. The apparatus according to claim 10, wherein the object information used for linking to at least one of an electronic commerce portal website, a website associated with the target object, information associated with the target object and an advertisement.

14. A video interacting system, comprising:
a video interacting apparatus, which comprises:
a video signal receiver for receiving a video broadcast program;
a network interface for receiving a video related tag, which relates to a target object, wherein the video broadcast program comprises a video frame having the target object;
a video related tag processing unit for generating synchronous information, an object position and object information according to the video related tag;
a triggering region generating unit for generating a triggering region according to the object position;
an image synchronizing unit for synchronously overlapping the triggering region on the video frame according to the synchronous information when the video frame is displayed; and
a triggering apparatus for generating a key-press signal, wherein the video related tag processing unit receives the key-press signal to select the triggering region, such that the image synchronizing unit overlaps the object information on the video frame.

15. The system according to claim 14, wherein the video related tag processing unit outputs a notification signal to the triggering apparatus according to the video related tag when the target object is displayed, the triggering apparatus generates an indication signal, which indicates that the triggering region is overlapped on the video frame, according to the notification signal.

16. The system according to claim 15, wherein the indication signal is an audible signal, a vibration signal or a lighting signal.

17. The system according to claim 14, wherein the triggering region is displayed.

18. The system according to claim 14, wherein the triggering region is hidden.

19. The system according to claim 14, wherein the object information used for linking to at least one of an electronic commerce portal website, a website associated with the target object, an information associated with the target object, and an advertisement.

20. An apparatus for generating a video related tag, which relates to a target object, the apparatus used for generating the video related tag according to a video broadcast program, the video broadcast program comprising a video frame having the target object, the apparatus comprising:
a synchronous information generator for generating synchronous information according to the target object;
an object position generator for generating an object position according to the target object;
an object information generator for generating object information according to the target object; and
a video related tag generator for generating the video related tag according to the synchronous information, the object position and the object information.

21. The apparatus according to claim 20, wherein the object information used for linking to at least one of an electronic commerce portal website, a website associated with the target object, an information associated with the target object, and an advertisement.

22. The apparatus according to claim 20, further comprising:
an image recognition apparatus for executing image recognition to find out the target object according to the video broadcast program.
